(19) United States
(12) Patent Application Publication
(10) Pub. No.: US 2006/0112971 A1
(43) Pub. Date: Jun. 1, 2006

(54) Method of eliminating galvanic corrosion in copper CMP

(75) Inventors: Han-Hsin Kuo, Tainan (TW); Hsin-Hsien Lu, Hsin-Chu (TW); Ying-Ho Chen, Taipei (TW); Syun-Ming Jang, Hsin-Chu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/999,277

(22) Filed: Nov. 30, 2004

(51) Int. Cl. C23G 1/00; B08B 7/00; B08B 3/00

(52) U.S. Cl. 134/2; 134/26; 134/28; 134/6

(57) ABSTRACT

A method for cleaning a semiconductor wafer surface comprises sweeping the semiconductor wafer surface and applying a first cleaning solution having a first pH, stop applying the first cleaning solution and applying a first rinsing solution to the semiconductor wafer surface, the first rinsing solution having a second pH that is significantly different from the first pH, sweeping the semiconductor wafer surface and applying a second cleaning solution having a third pH, and stop applying the second cleaning solution and applying a second rinsing solution to the semiconductor wafer surface, the second rinsing solution having a fourth pH that is significantly different from the third pH.

### BACKGROUND

Chemical mechanical planarization or CMP is a common technique for polishing the surface of a wafer using chemical slurries and mechanical abrasion. CMP is commonly used to planarize copper metallization so that only copper deposited inside contact and via openings for interconnects remains. However, defects such as recesses and copper redeposition as a result of galvanic corrosion have been observed.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIGS. 1 and 2 are cross-sectional diagrams of a copper metallization before and after a CMP process;

FIG. 3 is a simplified flowchart of an embodiment of a post-CMP cleaning process that does not result in defects due to galvanic corrosion;

FIG. 4 is a pH vs. time plot of an embodiment of the post-CMP cleaning process; and

FIG. 5 is a pH vs. time plot of another embodiment of the post-CMP cleaning process.

### DETAILED DESCRIPTION

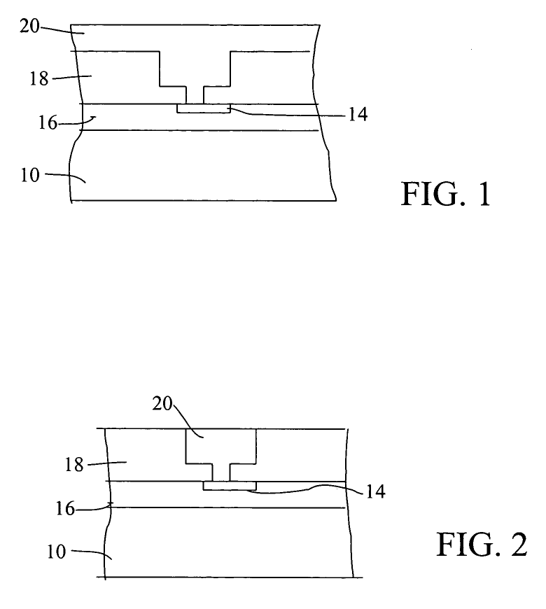

FIGS. 1 and 2 are cross-sectional diagrams of a copper metallization before and after a CMP process, respectively. In FIG. 1, onto a substrate 10 a dielectric layer 16 is formed, into which metal lines 14 are deposited. An insulting layer 18 is formed above the dielectric layer. Insulating layer may be silicon dioxide, or a low dielectric constant (low k) material or a ultra low k material, such as borophosphosilicate glass (BPSG), borosilicate glass (BSG), phosphosilicate glass (PSG), fluorinated silica glass (FSG), SiLK, BLACK DIAMOND, and the like. A contact or via opening is etched in insulating layer 18, and a metal 20 such as copper, is deposited in the opening. The opening may be a single or dual damascene opening, for example. The copper may be deposited by a variety of techniques such as chemical vapor deposition, electroplating, electroless plating, etc. Thereafter, as seen in FIG. 2, copper layer 20 is polished down to expose insulating layer 18 and leaving copper substantially within the via/contact opening.

In general, an integrated cleaner using two brush scrubbers have been used to perform post-CMP cleaning. The brushes represent some type of mechanism that makes physical contact with the wafer surface to sweep off or otherwise remove materials left on the wafer surface after the CMP process. Such mechanism may be embodied in a physical form other than brushes or brush scrubbers. These integrated cleaners may incorporate a megasonic rinsing tank prior to the two brushes, and a spin dry module after the two brushes. The two brushes are applied serially to the surface to remove residual CMP slurry, polishing byproduct and particles. In a conventional process, a weak acid solution such as citric acid is used when the first brush is applied to the wafer surface. A deionized water rinse is then used prior to applying a second brush to the wafer surface. A second deionized water rinse is then used after polishing with the second brush. The second brush cleaning process is typically not applied with any acidic solution but only with a deionized water rinse. A common result of this cleaning process is undesirable defects such as recesses and copper redeposition in certain areas of the wafer surface, particularly where there are small areas or “islands” of copper metallization.

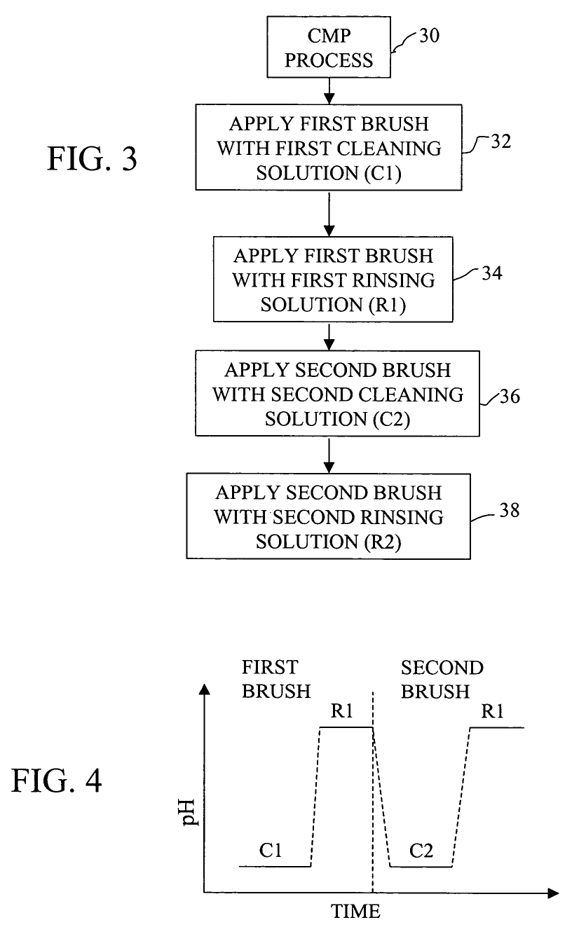

FIG. 3 is a simplified flowchart of an embodiment of a post-CMP cleaning process that does not result in defects due to galvanic corrosion. In step 30, the wafer undergoes a CMP process. Thereafter, as part of a post-CMP cleaning process, a first brush (also called brush scrubber) is applied to the wafer surface with a cleaning solution in step 32. In an embodiment of the post-CMP cleaning process, the cleaning solution comprises a low pH chemical such as a weak citric acid solution. The cleaning solution may further comprise other additives such as surfactants to aid in the cleaning process. A rinse step is then carried out in step 34. The rinsing solution may comprise deionized water. Referring to FIG. 4, it may be seen that there may be a difference in pH between the cleaning solution and the rinsing solution of at least 2. In step 36, when the second brush is applied to the wafer surface, a second cleaning solution is used. The second cleaning solution may be a solution that has a low pH such as a weak citric solution. Following in step 38, a second rinsing solution is used. FIG. 4 shows that there is also at least a difference of 2 in pH between the cleaning solution and the rinsing solution. In other words, the delta pH (ΔpH) is greater than or equal to 2. The second rinsing solution may be a deionized water solution.

In particular, during the application of the first brush scrubber, a first cleaning solution may be supplied for the duration of about 10 to 25 seconds, for example, followed by a delivery of a first deionized water for about 28 seconds, for example. During the application of the second brush scrubber, a second cleaning solution may be supplied for the duration of about 10 to 25 seconds, for example, followed by a delivery of a second deionized water for about 28 seconds, for example. The first cleaning solution and the second cleaning solution may be similar with similar concentrations, or may be dissimilar with dissimilar concentrations. The first rinsing solution and the second rinsing solution may be similar with similar concentrations, or may be dissimilar with dissimilar concentrations.

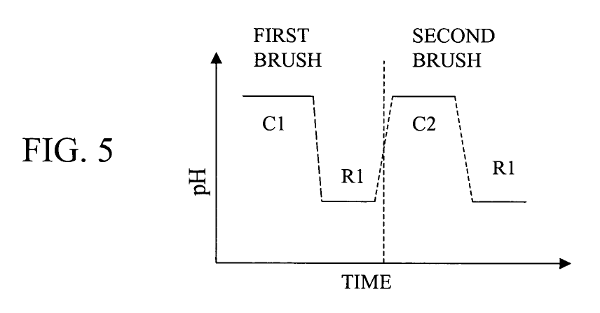

It may be seen from FIG. 4 that the wafer surface is subjected to a large pH differential, or pH shock. The pH value of the cleaning solution and the rinsing solution changes dramatically and suddenly and a result of this process is the elimination or reduction of galvanic corrosion in post-CMP copper metallization. In an alternate embodiment as seen in FIG. 5, the cleaning solution may comprise a weak basic solution with a high pH, which when alternated with the deionized water rinsing solution, also delivers a large pH differential or pH shock. The technique described herein may also be applied by alternately using an acidic solution and a basic solution, for example, as the first and second cleaning solutions.

Although the cleaning process has been described in the context of post-CMP copper metallization to avoid galvanic corrosion, this process may be used in other contexts.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method for cleaning a semiconductor wafer surface, comprising:
sweeping the semiconductor wafer surface and applying a first cleaning solution having a first pH;
stop applying the first cleaning solution and applying a first rinsing solution to the semiconductor wafer surface, the first rinsing solution having a second pH that is significantly different from the first pH;
sweeping the semiconductor wafer surface and applying a second cleaning solution having a third pH; and
stop applying the second cleaning solution and applying a second rinsing solution to the semiconductor wafer surface, the second rinsing solution having a fourth pH that is significantly different from the third pH.

2. The method of claim 1, wherein the first pH and the second pH have a delta pH of at least 2.

3. The method of claim 1, wherein the third pH and the fourth pH have a delta pH of at least 2.

4. The method of claim 1, wherein the first cleaning solution comprises an acidic solution.

5. The method of claim 1, wherein the second cleaning solution comprises an acidic solution.

6. The method of claim 1, wherein the first rinsing solution comprises a deionized water solution.

7. The method of claim 1, wherein the second rinsing solution comprises a deionized water solution.

8. The method of claim 1, wherein the first cleaning solution comprises a basic solution.

9. The method of claim 1, wherein the second cleaning solution comprises a basic solution.

10. The method of claim 1, wherein the first cleaning solution and the second cleaning solution comprises a weak citric acid solution.

11. A method for cleaning a semiconductor wafer surface, comprising:
sweeping the semiconductor wafer surface and applying a first cleaning solution having a first pH;
stop applying the first cleaning solution and applying a first rinsing solution to the semiconductor wafer surface, the first rinsing solution having a second pH, the second pH and the first pH having a delta pH that is at least 2;
sweeping the semiconductor wafer surface and applying a second cleaning solution having a third pH; and
stop applying the second cleaning solution and applying a second rinsing solution to the semiconductor wafer surface, the second rinsing solution having a fourth pH, the fourth pH and the third pH having a delta pH that is at least 2.

12. The method of claim 11, wherein the first cleaning solution comprises an acidic solution.

13. The method of claim 11, wherein the second cleaning solution comprises an acidic solution.

14. The method of claim 11, wherein the first and second rinsing solutions comprise a deionized water solution.

15. The method of claim 11, wherein the first cleaning solution comprises a basic solution.

16. The method of claim 11, wherein the second cleaning solution comprises a basic solution.

17. A cleaning method, comprising:
brushing a surface with a first brush scrubber;
alternately applying a first solution and then a second solution with a significant pH differential;
brushing the surface with a second brush scrubber; and
alternately applying a third solution and then a fourth solution with a significant pH differential.

18. The method of claim 17, wherein the significant pH differential is at least 2.
